(19) United States
(12) Patent Application Publication
(10) Pub. No.: US 2008/0170844 A1
(43) Pub. Date: Jul. 17, 2008

(54) Camera wiper

(76) Inventor: Ehab M. Samuel, Newport Beach, CA (US)

Correspondence Address: SNELL & WILMER LLP (OC), 600 ANTON BOULEVARD, SUITE 1400, COSTA MESA, CA, 92626, US

(21) Appl. No.: 11/652,456

(22) Filed: Jan. 11, 2007

(51) Int. Cl. G03B 17/08

(52) U.S. Cl. 396/29

(57) ABSTRACT

A waterproof casing for enclosing a camera body with a lens, the waterproof casing having a housing defining a cavity for containing the camera body with the lens, the housing having a lens region positioned in front of the lens of the camera body, the lens region being transparent to light, and a wiper connected to the housing for clearing particles from the lens region.

### BACKGROUND OF THE INVENTION

1. Field of the Invention.

The invention relates generally to the field of photography. More particularly, the invention relates to a camera wiper.

2. Description of Related Art.

The quality or clarity of photographs taken by a camera depends in part on the cleanliness of the camera lens. If the lens has dust or water droplets on its surface, the quality of the photograph is poor, typically hazy or blurry in the regions that are covered by dust or water droplets.

Conventional cameras exposed to water, such as waterproof cameras, are designed to prevent water from entering the camera. Some waterproof cameras can be used in the rain or near the shoreline, while others can be used underwater. Both types of cameras have watertight connections to prevent the permeation of fluid inside the camera.

As shown in FIG. 1, the prior art waterproof camera assembly 11 has an opaque camera body 13 and a waterproof casing 15. The waterproof casing 15 is transparent at least in the regions 17 and 19 in front of the lens 21 and the viewfinder 23, respectively. The camera body 13 is configured to take photographs using, for example, a light-sensitive film or digital technology.

Modem improvements in waterproof cameras have focused on overcoming water pressure effects or internal air-pressure effects, so that the cameras can be used in deeper waters. As described in Takamura et al., U.S. Pat. No. 4,763,245, the camera can have an air-pressure adjusting mechanism for automatically keeping the air pressure in the inner space of the camera at a substantially constant level irrespective of the position of the lens barrel inside the waterproof casing. Homing et al., U.S. Pat. No. 5,689,735, describes a water-resistant camera casing with support projections and a back frame that prevent the water-resistant casing from pushing the rear cover substantially into the film clearance space in deeper waters.

While recent improvements have focused on the interior performance and functionality of the waterproof camera, little has been done to expand or improve on the functionality of its exterior casing 15. For example, a waterproof camera used in the rain or the sea may get water droplets on its casing 15 in the region 17 in front of the lens 21. A person will have to use a dry cloth or tissue to wipe off the water droplets on the region 17 of the casing 15. However, if the person is swimming in a body of water with no access to a dry cloth or tissue, the person has no choice but to use the waterproof camera with water droplets on the front of the lens 21. As a result, the quality of the photographs taken is poor since water droplets obscure the light entering into the camera.

Similarly, if a conventional camera has dust on its lens, and there is no available dry cloth or tissue to wipe the dust off, the pictures taken by the camera will be blurry.

With an ever increasing demand for improved picture quality, there remains a continuing need in the art for a convenient and functional camera lens wiper and/or a camera casing wiper.

### SUMMARY OF THE INVENTION

In one embodiment, a waterproof casing for enclosing a camera body with a lens, the waterproof casing having a housing defining a cavity for containing the camera body with the lens, the housing having a lens region positioned in front of the lens of the camera body, the lens region being transparent to light, and a wiper connected to the housing for clearing particles from the lens region. The waterproof casing may include a carrier attached to the wiper and connects to the exterior surface of the housing using a track that defines a pathway in front of the lens region, a hinge that allows the carrier to travel in a defined path in front of the lens region, or a string that allows the wiper to travel across the lens region. The wiper comes into contact with the exterior surface of the housing to clear water droplets.

In another embodiment, a camera assembly having a camera body with a lens and a track coupled to an exterior surface of the camera body. The track defines a pathway in front of the lens. A carrier slidably travels on the track. The carrier holds a lens wiper so that it comes into contact with the exterior surface of the lens for removing dust. The lens wiper has a plurality of bristles.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is an exploded perspective view of a prior art waterproof camera assembly.

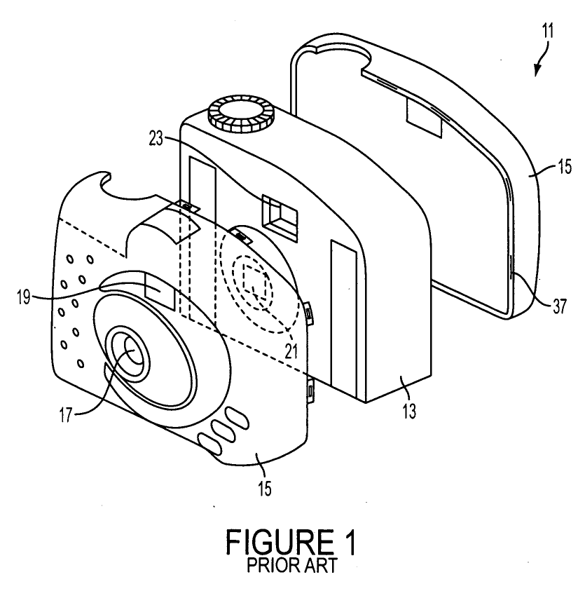

FIG. 2 is an exploded perspective view of a waterproof camera assembly, according to an embodiment of the invention.

FIG. 3 is a perspective view of a wiper assembly on a front cover of a waterproof camera, according to an embodiment of the invention.

FIG. 4 is a perspective view of a wiper assembly on a front cover of a waterproof camera, according to an embodiment of the invention.

FIG. 5 is a perspective view of a wiper assembly on a front cover of a waterproof camera, according to an embodiment of the invention.

FIG. 6 is a perspective view of a wiper assembly on a front cover of a waterproof camera, according to an embodiment of the invention.

FIG. 7 is a side view of the wiper assembly taken along line 7-7 of FIG. 6.

FIG. 8 is a cross-sectional view of the wiper assembly taken along line 8-8 of FIG. 3.

FIG. 9 is an alternate cross-sectional view of the wiper assembly taken along line 8-8 of FIG. 3.

FIG. 10 is a perspective view of a wiper assembly on a front cover of a waterproof camera, according to an embodiment of the invention.

FIG. 11 is a perspective view of a wiper assembly on a front cover of a waterproof camera, according to an embodiment of the invention.

FIG. 12 is a top view of a camera body, according to an embodiment of the invention.

FIG. 13 is a top view of the wiper assembly of FIG. 12.

### DETAILED DESCRIPTION

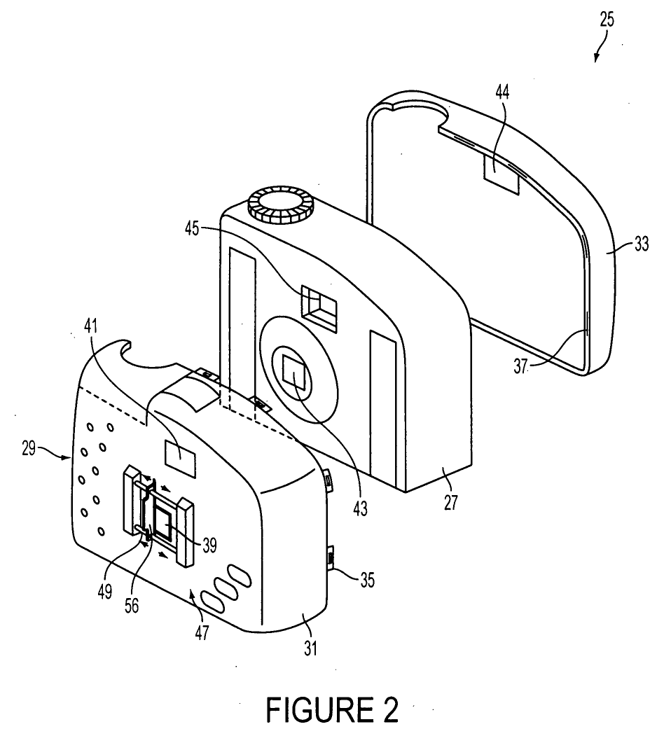

FIG. 2 is an exploded perspective of a waterproof camera assembly 25, according to an embodiment of the invention. The waterproof camera assembly 25 has an opaque camera body 27 and a waterproof casing 29 formed of a front cover 31 and a rear cover 33. The camera body 27 is configured to take photographs using, for example, a light-sensitive film or digital technology. The camera body 27 has a lens 43 and a viewfinder 45. The camera body 27 is adapted to be nested inside the waterproof casing 29.

The front and rear covers 31 and 33 may be coupled to one another by a fastening mechanism, such as tab 35 and groove 37, which is well known in the art. A waterproof sealing band (not shown), such as a rubber overlay, may be used between the front and rear covers 31 and 33 to prevent water from entering the casing 29.

The front cover 31 is transparent in at least two regions. It is transparent at lens region 39 in front of lens 43 and at viewfinder region 41 in front of viewfinder 45. The rear cover 33 is transparent in at least the viewfinder region 44 in the rear of viewfinder 45.

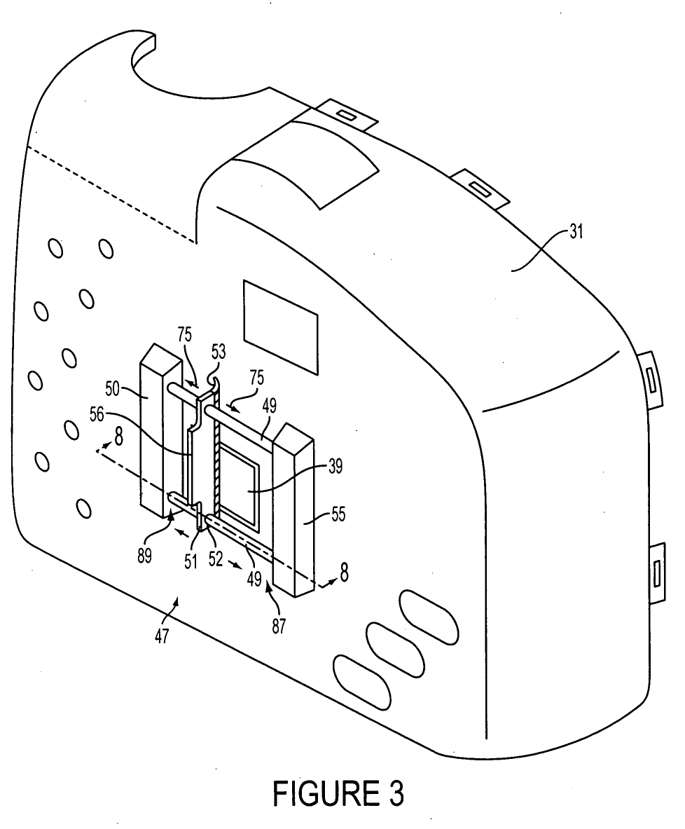

According to an embodiment of the invention, the front cover 31 includes a wiper assembly 47. FIG. 3 shows a more detailed view of the wiper assembly 47. The wiper assembly 47 has a track 49, a carrier 51, and a wiper 53.

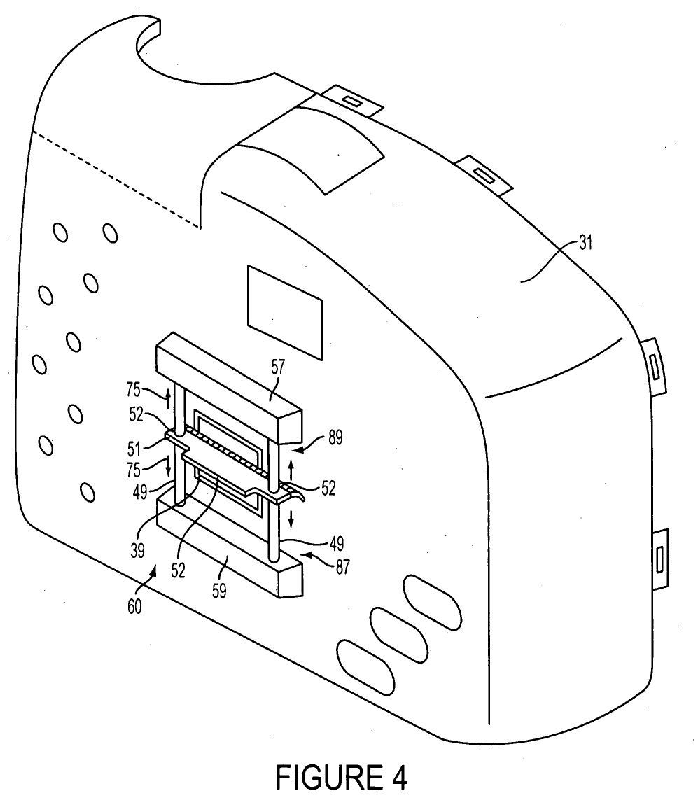

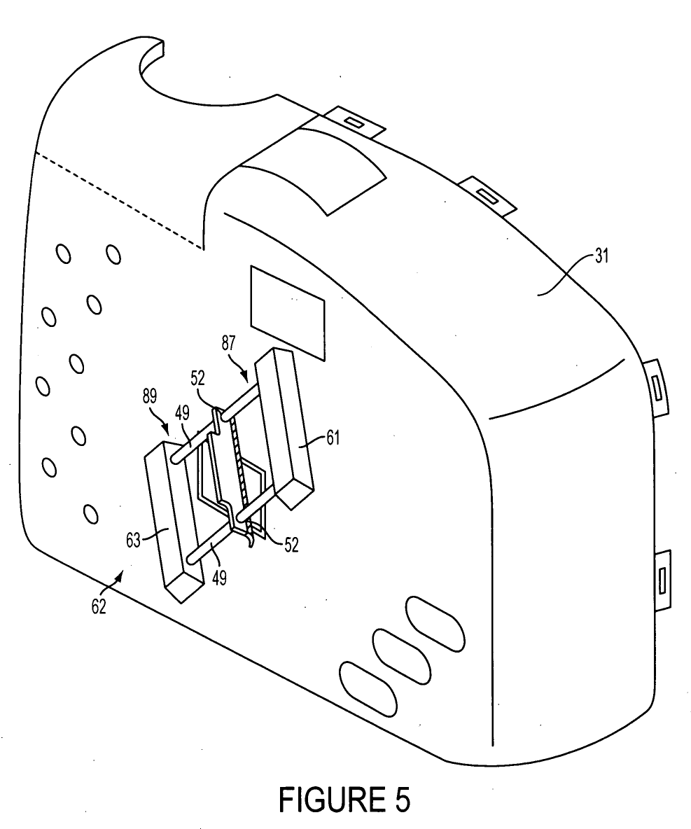

Track 49 is coupled to the front cover 31. For example, track 49 may be attached at both ends to vertical frame members 50 and 55, as shown in FIG. 3. The vertical frame members 50 and 55 may connect to or project from the front cover 31. Similarly, track 49 may be attached at both ends to horizontal frame members 57 and 59 or diagonal frame members 61 and 63, as shown in FIGS. 4 and 5, respectively. The horizontal frame members 57 and 59 of wiper assembly 60 may connect to or project from the front cover 31. The diagonal frame members 61 and 63 of wiper assembly 62 may connect to or project from the front cover 31.

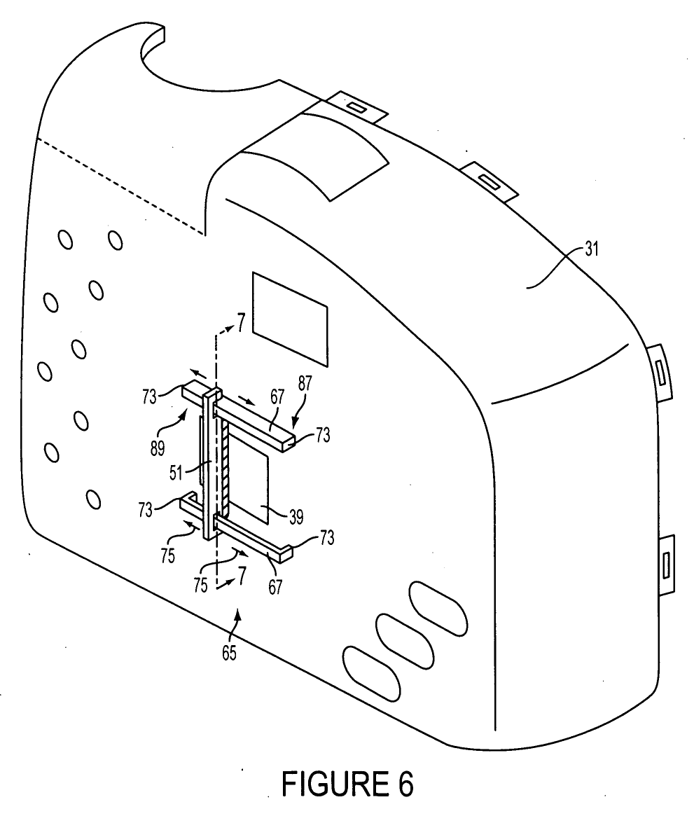

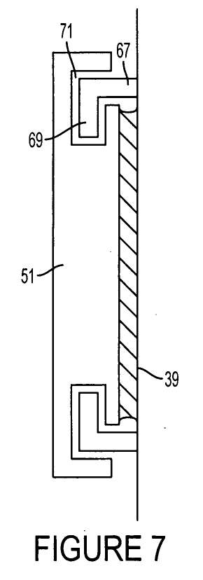

According to an embodiment of the invention, the track connects to or projects from the front cover 31. FIG. 6 is a perspective view of a wiper assembly 65 with a track 67 connecting to or projecting from the front cover 31. FIG. 7 is a side view of the wiper assembly 65 illustrated in FIG. 6, along lines 7-7. Track 67 has a flange 69 that slidably engages an aperture 71 of carrier 51. Track 67 has closed ends 73 to constrain the movement of the carrier 51 and prevent it from getting off track.

Track 49 or 67 defines a pathway 75 along the front cover 31 that guides carrier 51 to slide across the lens region 39. As shown in FIGS. 3-5, carrier 51 has an aperture 52 that allows track 49 to pass therethrough, thereby constraining the movement of the carrier 51 to the defined pathway 75. Tracks 49 or 67 may be made of plastic or metal material.

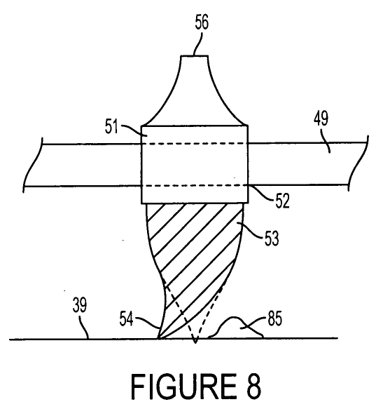

As shown in FIG. 3, carrier 51 may include a tab 56 to allow improved handling capability of carrier 51 for sliding it across the lens region 39. Coupled to the carrier 51 is a wiper that comes into contact with the lens region 39. The wiper may be made, for example, of a rubber or plastic material. The wiper may be fixed to the carrier 51 using a watertight adhesive. FIG. 8 is a cross-sectional view of the wiper assembly 47 illustrated in FIG. 3, along lines 8-8. The wiper assembly 47 has a wiper 53 with a tip 54 that comes into pressing contact with the lens region 39. Tip 54 slides across the lens region 39 to remove water droplets or particles 85 on the surface.

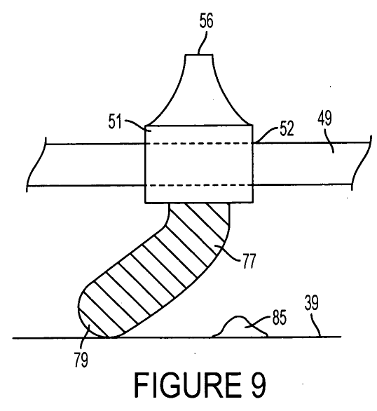

FIG. 9 shows an alternate shape of wiper 53. FIG. 9 illustrates a wiper 77 with a round tip 79 that comes into contact with the lens region 39. Round tip 79 slides across the lens region 39 to remove water droplets 85 on the surface.

In operation, carrier 51 is initially at a first position 87 on one end of track 49 or 67 that does not obstruct the lens 43 or lens region 39. Carrier 51 is moved across the exterior surface of lens 43 or lens region 39 to a second position 89 on the other end of track 49 or 67. In one embodiment, the second position 89 on the other end of track 49 or 67 does not obstruct the lens 43 or lens region 39. In another embodiment, the second position 89 is at the edge of lens 43 or lens region 39, in which case, the carrier 51 is moved back to the first position 87 so as not to obstruct the lens 43 or lens region 39. As the carrier 51 is moved across the lens 43 or lens region 39, wiper 53 or 77 slides across to remove water droplets 85 on the surface.

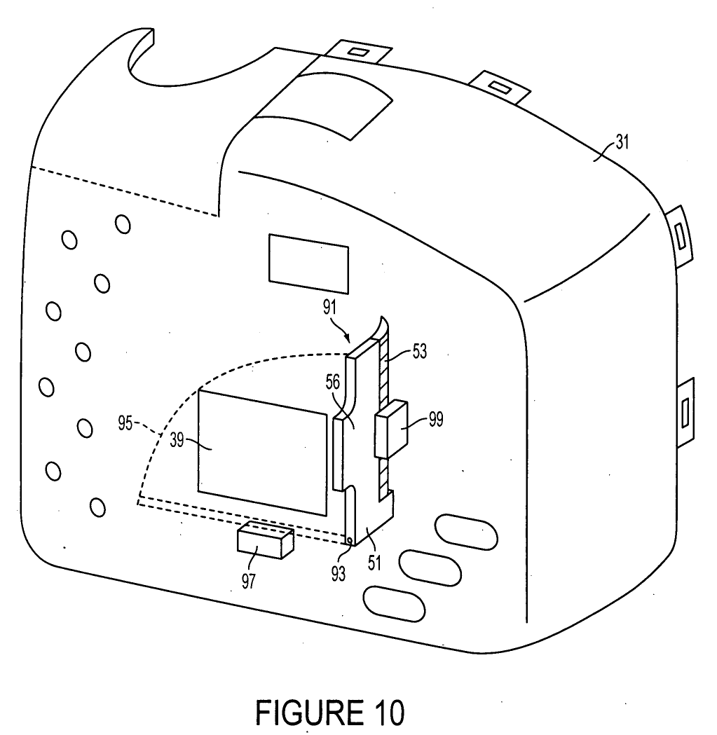

According to an embodiment of the invention, a wiper assembly is hinged to the front cover 31. FIG. 10 shows a wiper assembly 91 with carrier 51 and wiper 53 coupled to the front cover 31 using a hinge 93. The hinge 93 allows the carrier 51 to travel in a defined path 95 across the lens region 39. Stoppers 97 and 99 may be used to keep carrier 51 traveling beyond the defined path 95.

Carrier 51 holds wiper 53 so that it comes into contact with the exterior surface of the waterproof casing for removing water droplets. Carrier 51 preferably has a length that is greater than or equal to the diagonal length or diameter of lens region 39. Carrier 51 may include tab 56 that allows a user to slide carrier 51 along the defined path 95.

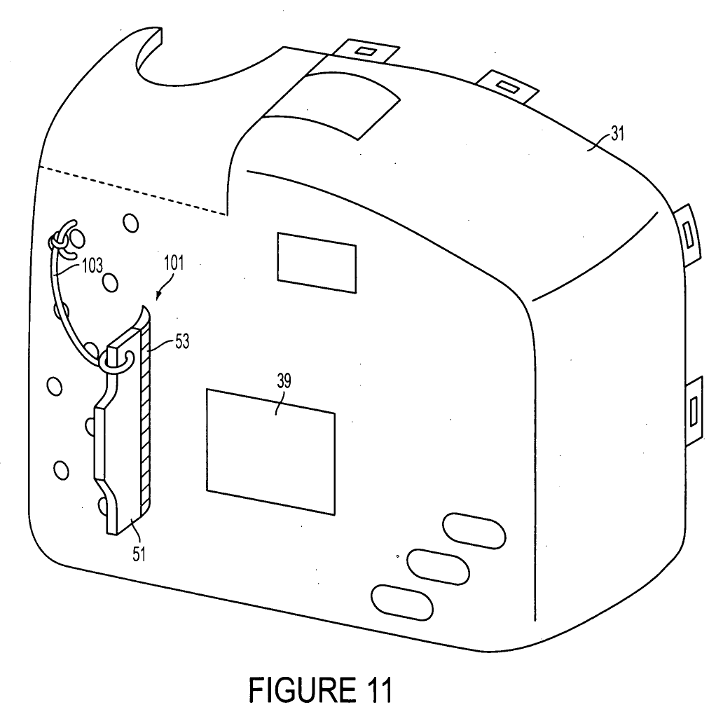

According to an embodiment of the invention, a wiper assembly is coupled to the waterproof casing 29 using a string. FIG. 11 shows a wiper assembly 101 with carrier 51 and wiper 53 coupled to the front cover 31 using a string 103. String 103 may be made of fabric or elastic material.

The string 103 couples carrier 51 to the waterproof casing 29 while allowing carrier 51 to be within reach of sliding wiper 53 across the lens region 39. The carrier 51 may be hanging on one side of the waterproof casing 29 by the string 103 or it may be fastened to the waterproof casing 29, for example, using a reciprocal groove in the waterproof casing 29 for retaining the carrier 51. In use, the carrier 51 is moved across the lens region 39 to allow wiper 53 to come into contact with the lens region 39.

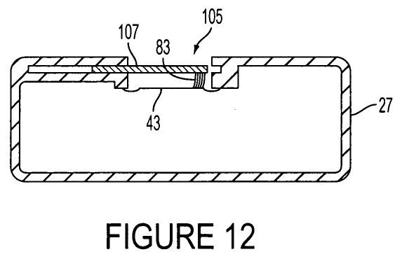

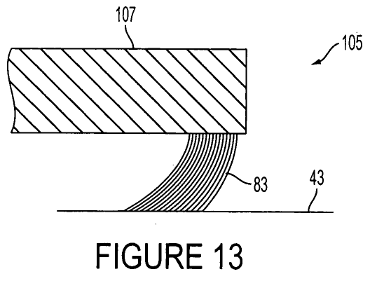

According to an embodiment of the invention, a wiper assembly is used to remove dust on the surface of lens 43. FIG. 12 illustrates a top view of camera body 27 having a dust wiper assembly 105. FIG. 13 shows a more detailed view of the wiper assembly 105. The wiper assembly 105 has a shutter 107 with a plurality of bristles 83. The bristles 83 are held by the shutter 105 so that they come into contact with lens 43 of camera body 27. The bristles 83 brush against the lens 43 to remove dust on the surface.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. For example, while the embodiments show carrier 51 moved manually across lens 43 or lens region 39 using tab 56, it is understood that the invention may have carrier 51 moved across lens 43 or lens region 39 electronically by techniques well known in the art. Furthermore, while the embodiments show a carrier holding a wiper, it is understood by a person skilled in the art that the wiper may be made of a self-supporting rigid material that does not require the use of the carrier to hold it in place.

Those skilled in the art will appreciate that various adaptations and modifications of the just described preferred embodiments may be configured without departing from the scope and spirit of the invention. Therefore, it is to be understood that, within the scope of the appended claims, the invention may be practiced other than as specifically described herein.

What is claimed is:

1. A waterproof camera assembly comprising:
a camera body with a lens;
a waterproof casing having an exterior surface and enclosing the camera body;
a track coupled to the exterior surface of the waterproof casing, defining a pathway in front of the lens;
a carrier traveling on the track; and
a wiper attached to the carrier so that the wiper comes into contact with the exterior surface of the waterproof casing.

2. The waterproof camera assembly of claim 1, wherein the waterproof casing has vertical frame members on both ends of the track for coupling the track to the exterior surface of the waterproof casing.

3. The waterproof camera assembly of claim 1, wherein the waterproof casing has horizontal frame members on both ends of the track for coupling the track to the exterior surface of the waterproof casing.

4. The waterproof camera assembly of claim 1, wherein the track projects from the exterior surface of the waterproof casing.

5. The waterproof camera assembly of claim 1, wherein the track projects from the exterior surface of the waterproof casing, the track having a flange that slidably engages an aperture in the carrier.

6. The waterproof camera assembly of claim 1, wherein the wiper is a rubber material.

7. A waterproof casing for enclosing a camera body with a lens assembly, the waterproof casing comprising:
a housing having an exterior surface and defining a cavity for containing the camera body with the lens assembly;
a track coupled to the exterior surface of the housing, defining a pathway in front of the lens assembly;
a carrier travels along the track; and
a wiper attached to the carrier so that the wiper comes into contact with the exterior surface of the housing.

8. The waterproof casing of claim 7 further comprising vertical frame members on both ends of the track for coupling the track to the exterior surface of the housing.

9. The waterproof casing of claim 7 further comprising horizontal frame members on both ends of the track for coupling the track to the exterior surface of the housing.

10. The waterproof casing of claim 7 further comprising diagonal frame members on both ends of the track for coupling the track to the exterior surface of the housing.

11. The waterproof casing of claim 7, wherein the track projects from the exterior surface of the housing.

12. The waterproof casing of claim 7, wherein the track projects from the exterior surface of the housing, the track having a flange that slidably engages an aperture in the carrier.

13. The waterproof casing of claim 7, wherein the wiper is a rubber material.

14. A waterproof casing for enclosing a camera body with a lens, the waterproof casing comprising:
a housing defining a cavity for containing the camera body with the lens, the housing having a lens region positioned in front of the lens of the camera body, the lens region being transparent to light; and
a wiper connected to the housing for clearing particles from the lens region.

15. The waterproof casing of claim 14, wherein the wiper is connected to the housing using a track that defines a pathway in front of the lens region.

16. The waterproof casing of claim 14, further comprising a carrier connected to the housing using a track that defines a pathway in front of the lens region, the track projecting from the housing, having a flange that slidably engages an aperture in the carrier, the carrier attached to the wiper so that the wiper comes into contact with the lens region.

17. The waterproof casing of claim 14, further comprising a carrier connected to the housing using a hinge that allows the carrier to travel in a defined path in front of the lens region, the carrier holding the wiper so that the wiper comes into contact with the lens region.

18. The waterproof casing of claim 14, wherein the wiper is connected to the housing using a string that allows the wiper to travel across the lens region.

19. The waterproof casing of claim 14, wherein the wiper is connected to the housing using a string that allows the carrier to travel across the lens region, the string is made from a material that is selected from a group consisting of a fabric material and an elastic material.

20. The waterproof casing of claim 14, wherein the wiper is made from a material that is selected from a group consisting of a rubber material and a plastic material.
